(19) United States
(12) Patent Application Publication
(10) Pub. No.: US 2022/0349912 A1
(43) Pub. Date: Nov. 3, 2022

(54) Sample Injection Probe Washing

(71) Applicant: Life Technologies Corporation, Carlsbad, CA (US)

(72) Inventors: Daniel Quigley, Eugene, OR (US); Saul Selberg, Eugene, OR (US); Derek Robinson, Marcola, OR (US); Eric Finan, Eugene, OR (US)

(21) Appl. No.: 17/729,380

(22) Filed: Apr. 26, 2022

Related U.S. Application Data
(60) Provisional application No. 63/180,142, filed on Apr. 27, 2021.

(51) Int. Cl. G01N 35/10

(52) U.S. Cl. CPC G01N 35/1004; G01N 35/1011

(57) ABSTRACT

Provided are handling systems and methods for sample processing. The systems can include a sample container and a probe. A system can be convertible between a loading state in which a user loads sample into the sample container, a sampling state in which relative motion between the sample container and the probe places the probe and sample container into fluid communication with one another so that the probe can aspirate sample from the sample container, and a washing state in which rinse fluid is expressed through the probe so as to remove unwanted material from within the probe, with the rinse fluid being collected by a wash manifold.

### CROSS-REFERENCE TO RELATED APPLICATIONS

The present application claims priority to and the benefit of U.S. patent application No. 63/180,142, “Sample Injection Probe Washing” (filed Apr. 27, 2021), the entirety of which application is incorporated herein by reference for any and all purposes.

### TECHNICAL FIELD

The present disclosure relates to the field of fluid sample handling.

### BACKGROUND

Flow cytometers frequently use a probe or other tube as the interface between a user-supplied sample and the device, with the probe transporting (e.g., via aspiration) sample material into the device for further analysis. Such devices are often used to process multiple samples one after another in a sequential fashion.

When a user analyzes multiple samples one after another, however, the issue known as “carryover” can arise, in which some amount of a first sample remains in the system, either on the probe or elsewhere, which amount of first sample is then present while a second (i.e., subsequent) sample is analyzed and which amount of first sample can contaminate or otherwise influence the analysis of the second sample.

A number of attempts have been made to reduce or eliminate carryover, but these attempts have certain drawbacks. Some systems utilize manual approaches, such as having the user flush and/or wipe down certain system components, but these manual approaches can be time-consuming, unreliable, expose the user to risk, and also expose the system to user-caused contamination. Other systems incorporate moving automated washing components, but because these moving components are exposed to the user, there is a risk of injury (e.g., pinching) to the user as well as a risk of exposing the user to material (e.g., the carried-over material) that resides within the system. Accordingly, there is a long-felt need for systems and methods that reduce or even eliminate carryover between consecutive sample runs, in particular carryover that occurs in the context of flow cytometry operations.

### SUMMARY

In meeting the described long-felt needs, the present disclosure provides fluid sample handling systems, comprising:
a sample container holder configured to receive a sample container, the sample container holder being moveable between at least (1) a first sample holder position and (2) a second sample holder position;
a sample probe, the sample probe defining a proximal end configured for fluid communication with the sample container, the sample probe configured to communicate therethrough, in a first direction, fluid aspirated from the sample container, the sample probe defining a sample probe axis along which the sample probe is optionally moveable between at least (1) a first sample probe position for aspirating fluid from the sample container when the sample holder is located at the first sample holder position and (2) a second sample probe position for washing;
a wash manifold, the wash manifold being moveable along a wash manifold path between at least a first wash manifold position and a second wash manifold position, the second wash manifold position being such that when the wash manifold is located at the second position, the wash manifold receives fluid communicated from the proximal end of the sample probe when the sample probe is located at the second probe position and the wash manifold interrupts fluid communication between the proximal end of the sample probe and a sample container received by the sample holder, and the wash manifold path optionally being perpendicular to the sample probe axis.

Also provided are fluid sample handling systems, comprising:

a sample container region;

a probe configured for aspiration of a fluid sample from a sample container located at the sample container region; and

a wash manifold,

the fluid sample handling system being convertible between:

a sampling state in which the probe is in a sampling position and the sample container region is in a sampling position such that the probe is in fluid communication with a container located at the sample container region,

a washing state in which the probe is in a washing position and the wash manifold is in a washing position such that the probe is in fluid communication with the wash manifold and the probe is free of fluid communication with a container located at the sample container region, and

a loading state in which the sample container region is in a loading position such that a user can locate a container at the sample container region without placing the container into fluid communication with the probe.

Further provided are methods, comprising:

with a probe in a sampling position, collecting a sample from a sample container in a sampling position;

translating the probe in a direction of probe translation to a washing position;

washing the probe with a rinse fluid while the probe is in the washing position; and

collecting the rinse fluid from the probe.

Additionally provided are methods, comprising:

effecting movement of a probe toward a sample container,

in response to the sample probe being located at a first sample probe position, with a first restorative spring effecting resistance against the movement of the probe toward the sample container;

collecting a sample with the probe from a sample container;

effecting movement of the sample probe toward a wash manifold;

in response to the sample probe being located at a second sample probe position, with a second restorative spring effecting resistance against the movement of the probe toward the wash manifold;

washing the probe with a rinse fluid while the probe is in the washing position; and

collecting the rinse fluid from the probe.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various aspects discussed in the present document. In the drawings:

FIG. 1 provides a view of an example system according to the present disclosure;

FIG. 2 provides a view of an example system according to the present disclosure;

FIG. 3 provides a view of an example system according to the present disclosure;

FIG. 4 provides a view of an example system according to the present disclosure;

FIG. 5 provides a side view of a system according to the present disclosure in a first (unloaded) state;

FIG. 6 provides a side view of a system according to the present disclosure in a second (sample-loaded) state;

FIG. 7 provides a side view of a system according to the present disclosure in a third (sample engaged with probe) state;

FIG. 8 provides a side view of a system according to the present disclosure in a fourth (probe aspirating sample) state;

FIG. 9 provides a side view of a system according to the present disclosure in a fifth (washing) state;

FIG. 10A provides a view looking down on a system according to the present disclosure before the wash manifold has been brought into engagement with the probe via linear movement in the x-direction;

FIG. 10B provides a view looking down on a system according to the present disclosure after the wash manifold has been brought into engagement with the probe via linear movement in the x-direction;

FIG. 11A provides a view looking down on a system according to the present disclosure before the wash manifold has been brought into engagement with the probe via rotational movement in the x-y plane; and

FIG. 11B provides a view looking down on a system according to the present disclosure after the wash manifold has been brought into engagement with the probe via rotational movement in the x-y plane.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints, 2 grams and 10 grams, and all the intermediate values). The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” may be apparent from the context, such as rounding off, so, for example “about 1” can also mean from 0.5 to 1.4. Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

### FIGURES

The attached figures are illustrative only and do not serve to limit the scope of the present disclosure or the appended claims.

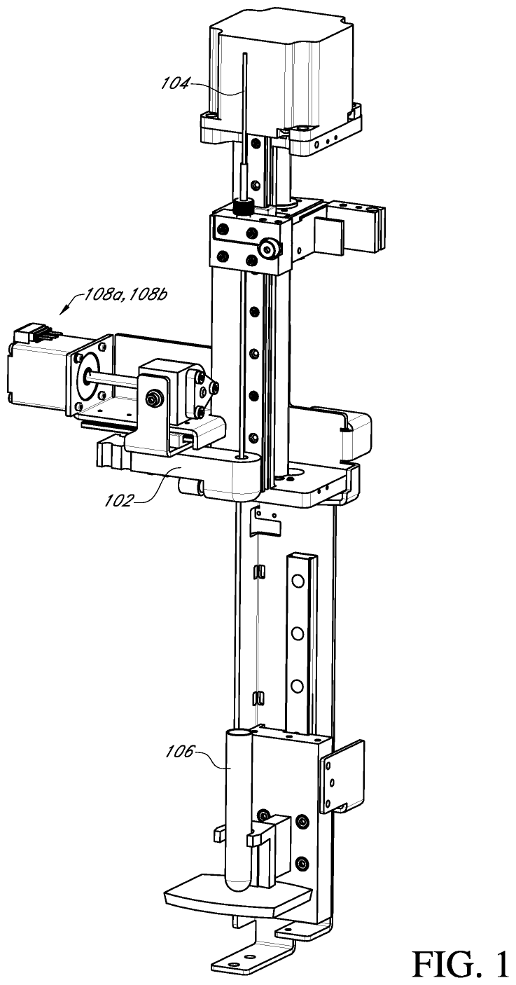

FIG. 1 provides a view of an exemplary system according to the present disclosure. As shown, a system can include a probe 104. Relative motion between probe 104 and sample container 106 can be used to, e.g., insert probe 104 into sample container 106. The relative motion can be effected by, e.g., moving probe 104 downward into sample container 106, moving sample container 106 upward towards probe 104, or any combination thereof. Probe 104 and sample container 106 can be configured so that one or both is movable in only one direction, e.g., upward/downward in the z-direction, but this is not a requirement or limitation. For example, one or both of probe 104 and sample container 106 can be rotatable relative to the other. For example, sample container 106 can be rotatable about an axis extending in the z-direction such that sample container 106 is rotated between a first position in which sample container 106 is in register with probe 104 and a second position in which sample container 106 is not in register with probe 104. Likewise, probe 104 can be rotatable about an axis extending in the z-direction such that probe 104 is rotated between a first position in which probe 104 is in register with sample container 106 and a second position in which probe 104 is not in register with sample container 106.

Wash manifold 102 can be moved (e.g., via one or more motion stages, shown as 108a and 108b) so as to engage with probe 104. A motion stage can operate so as to translate wash manifold 102 in a direction that is non-parallel with a direction in which probe 104 moves. For example, probe 104 can move upwards and/or downwards in the z-direction, and wash manifold can move in the x-y plane so as to become positioned for engagement with probe 104. Without being bound to any particular embodiment, wash manifold 102 can be moved in the x-y plane while probe 104 is located at a distance from sample container 106 so as to place wash manifold 102 (or at least a portion thereof) into register with probe 104. Probe 104 can then be rinsed with a rinsing fluid (e.g., water, saline, buffer, or other fluid), with the rinsing fluid being collected by wash manifold 102. Although not shown in FIG. 1, a system according to the present disclosure can optionally include a cup, shelf, tray, gutter, or other fluid collector or diverter below wash manifold 102 so as to collect excess fluid. Such fluid collectors and diverters can be moveable, e.g., such that they are positioned between the probe and the sample container (or sample container holder) while the probe is being rinsed and are then removed so as to allow access between the probe and the sample container.

Sample container 106 can be engaged with a sample container holder (not labeled) that translates sample container 106 in one or more directions, e.g., toward probe 104 or away from probe 104.

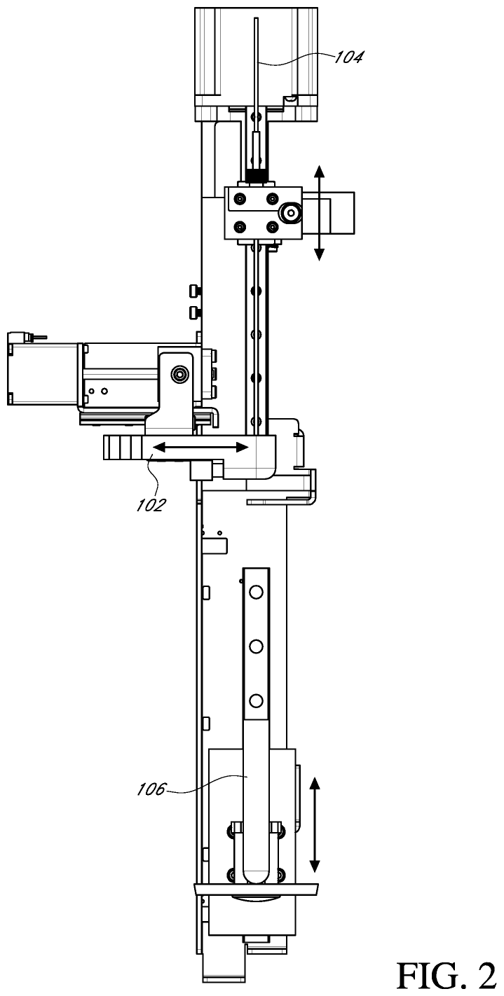

Further illustration is provided by FIG. 2. As shown in FIG. 2, relative motion between probe 104 and sample container 106 can allow for positioning the probe 104 within sample container 106, which positioning allows probe 104 to aspirate sample from sample container. As shown, sample container 106 can engage with a sample container holder (not labeled) that translates up and down so as to allow a user to load or unload the sample container as well as to place sample container 106 into engagement with probe 104 so that probe 104 can aspirate sample from sample container 106. Also as shown in FIG. 2, wash manifold 102 can move (e.g., linearly, rotatially/rotatably) such that the wash manifold is in engagement with probe 104 and can receive rinsing fluid that is expressed through probe 104. Wash manifold 102 can have a solid bottom so as to mitigate rinse fluid dropping down into sample container 106 or otherwise into the region surrounding the sample container 106 that the user can access, which region can be termed the “cove.”

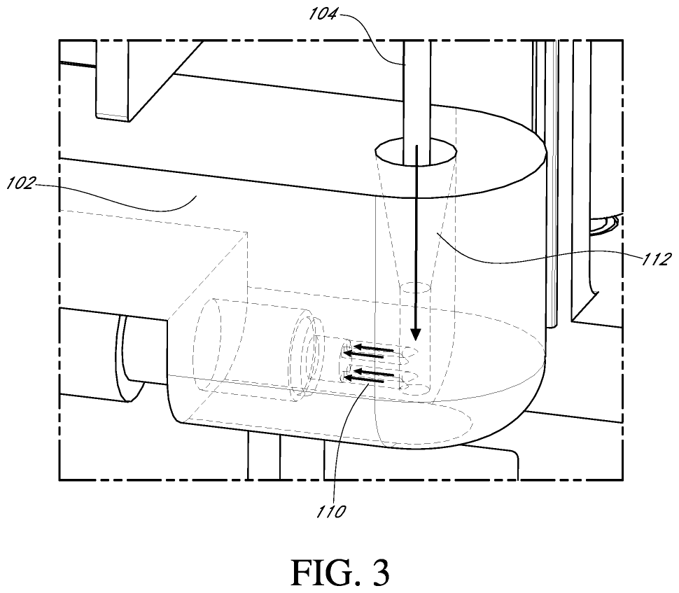

Additional detail is provided in FIG. 3, which figure provides an illustration of wash manifold 102 engaged with probe 104. As shown, probe 104 can be inserted into a receiving portion 112 (which can be funnel-shaped) of wash manifold 102. Rinsing fluid can be expressed through probe 104 so as to clear probe 104 (as well as to clear other components or fluid channels that can be upstream of probe 104) of any carryover material that may remain from a previous sample run. The rinsing fluid can be collected (as shown) by wash manifold 102, e.g., via channel 110 of wash manifold 102. Vacuum can be applied to channel 110 so as to facilitate collection of rinse fluid expressed from probe 104 into wash manifold 102.

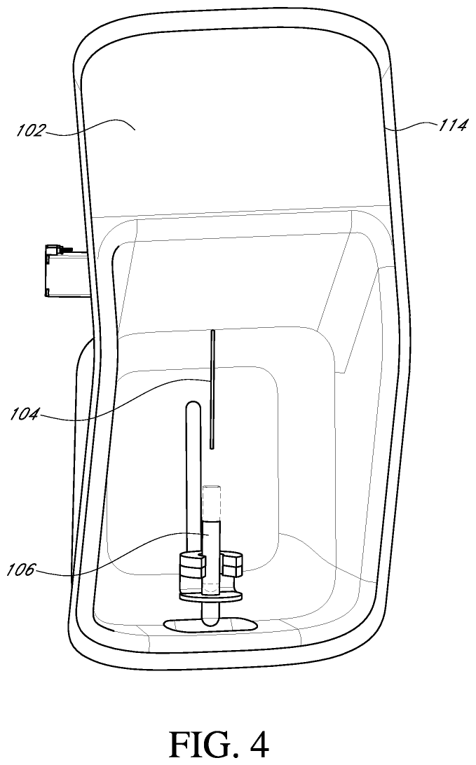

FIG. 4 provides a further view of the exemplary system of FIGS. 1-3, showing the view of such a system from the perspective of the user. As shown, a system can include a housing 114 or other panel that is interposed between the user and wash manifold 102. In this way, the user need not see the actions of wash manifold 102. Further, the actions of wash manifold 102 are not physically accessible to the user, thereby preventing the user from accidentally interfering with the actions of wash manifold 102 or the rinsing actions of the system, which rinsing can take place behind housing 114. Although not shown in FIG. 4, system controls and/or system monitors can be located on or near housing 114.

As shown in FIG. 4, sample container 106 is positioned for loading (e.g., via pipette or other modality) of a sample by the user. Probe 104 is shown in a down position (for reference purposes). In operation, probe 104 can be located behind housing 114 during operation of the system, e.g., during the steps of aspiration and also the steps of rinsing. As an example, a user can load sample container 106 with a sample, and then sample container can be moved (manually and/or in an automated fashion) such that sample container 106 engages with probe 104 while the end of probe 104 is located behind housing 114. In this way, the user's interaction with the system is limited to loading sample container 106, as the steps of sample aspiration from sample container 106 by probe 104 and subsequent rinsing of probe 104 are performed while probe 104 is located behind housing 114.

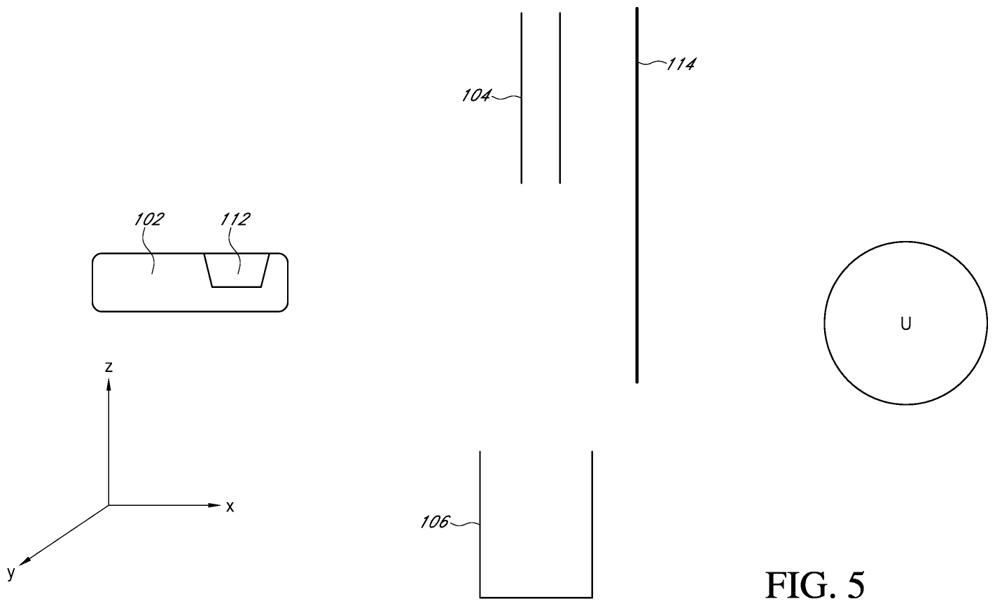

FIG. 5-FIG. 8 provide a view of a system according to the present disclosure in a variety of states. As shown in FIG. 5, a user located at location U can access sample container 106, while housing 114 is imposed between location U and probe 104 and wash manifold 102. (As described elsewhere herein, wash manifold 102 can include receiving portion 112.) In this way, a user located at location U does not interfere with probe 104 and/or wash manifold 102.

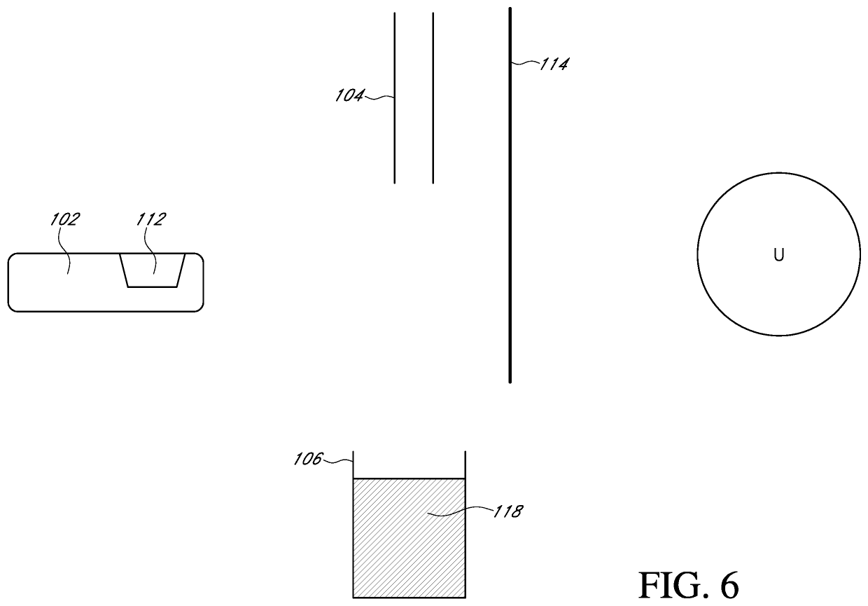

As shown in FIG. 6, sample container 106 can be filled with sample 118, e.g., by a user. A user can load sample 118 into the sample container. The user can lift sample container 106 upwards into place for probe 118 to aspirate sample from sample container 106; alternatively, the system can operate to lift sample container in an automated fashion. A system can effect automated and independent movement of one or both of wash manifold 102 ad probe 104 so as to control washing operations and timing. The foregoing can be useful for, e.g., executing processes in parallel and decreasing wait time for the user.

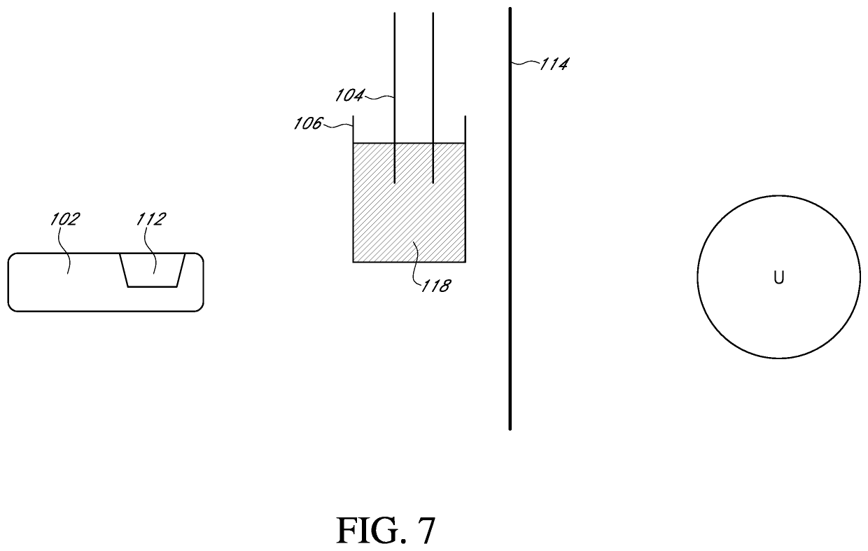

As shown in FIG. 7, sample container 106 can be translated upwards behind housing 114 such that probe 104 is in fluid communication with sample 118 located in sample container 106.

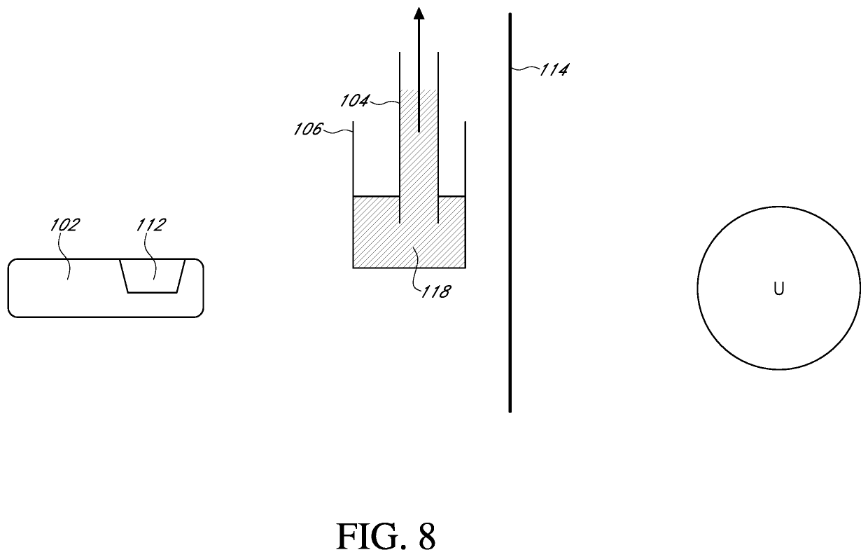

In FIG. 8, relative motion between sample container 106 and probe 104 effects positioning of probe 104 within sample container 106, preferably behind housing 114. Probe 104 can aspirate sample 118, e.g., such that sample 118 is transported to an analysis portion of the system. An analysis portion can be a concentration portion, e.g., a portion that effects particle concentration via acoustic radiation, hydrodynamic focusing, and the like.

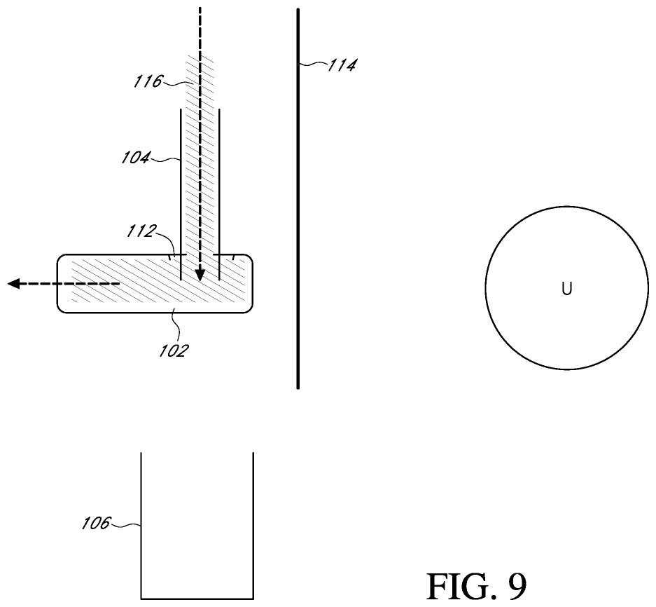

As shown in FIG. 9, relative motion between sample container 106 and probe 104 can allow for sufficient space between sample container 106 and probe 104 to allow for engagement between wash manifold 102 and probe 104, e.g., via movement of wash manifold into a space between sample container 106 and probe 104. Rinse fluid 116 can be communicated (e.g., from a source of rinse fluid) through probe 104 so as to rinse extraneous sample out of probe 104 and then collected by wash manifold 102. The foregoing can be conducted behind housing 114, e.g., partially or totally out of view of a user located at a location (e.g., location U shown in FIG. 5) that is separated by housing 114 from wash manifold 102. The separation effected by the housing can be such that the wash manifold is not physically accessible to the user.

It should be understood that probe 104 and sample container 106 (and/or a sample container holder) can move independently of each other. As described elsewhere herein, the sample container (or a sample container holder) can be raised or lowered by a user, but can also be raised or lowered in an automated fashion. Once the sample container reaches a certain location, the system can automatically lower the probe into the sample container and then effect aspiration of the sample from the sample container. Once aspiration is effected, the sample container can be lowered, the wash manifold moved into fluid communication with the probe, and rinse fluid expressed through the probe so as to flush out the probe; a vacuum can be used to carry rinse fluid away from the probe, e.g., to a waste collection location. During this rinse cycle, a user can introduce a new sample and/or sample container to the system.

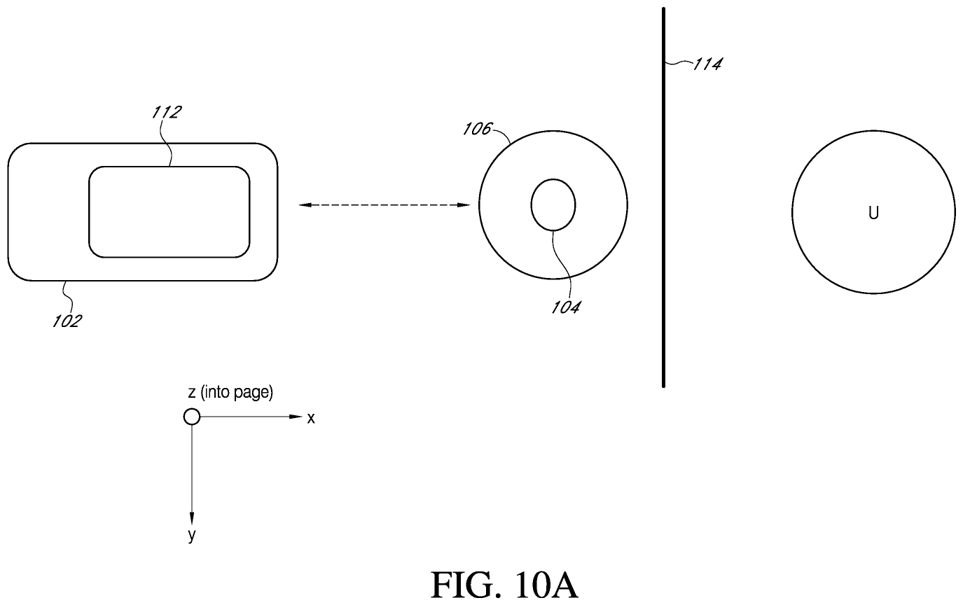

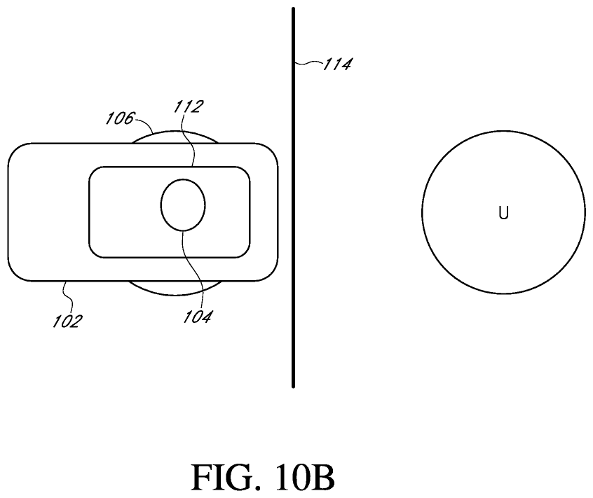

FIG. 10A provides a view looking down on a system according to the present disclosure before the wash manifold has been brought into engagement with the probe via linear movement in the x-direction. As shown, the user (located at location U) can be separated from one or more components of the system by housing 114. Probe 104 can be in register (in the x-y plane) with sample container 106 so as to allow for insertion of probe 104 into sample container 106.

After probe 104 has aspirated sample from sample container 106, relative motion between probe 104 and sample 106 can allow for wash manifold 102 (with receiving portion 112) to be moved (e.g., linearly in the x-y plane) so as to place the receiving portion 112 into register with probe 104. This is shown in FIG. 10B, which provides a view looking down on a system according to the present disclosure after the wash manifold has been brought into engagement with the probe via linear movement in the x-direction. Rinse fluid (not shown) can be communicated through probe 104 so as to remove undesired material (e.g., carryover from a previous sample run) from probe 104. The rinse fluid can then be collected by wash manifold 102 and transported to a waste collection location or transferred elsewhere for further processing.

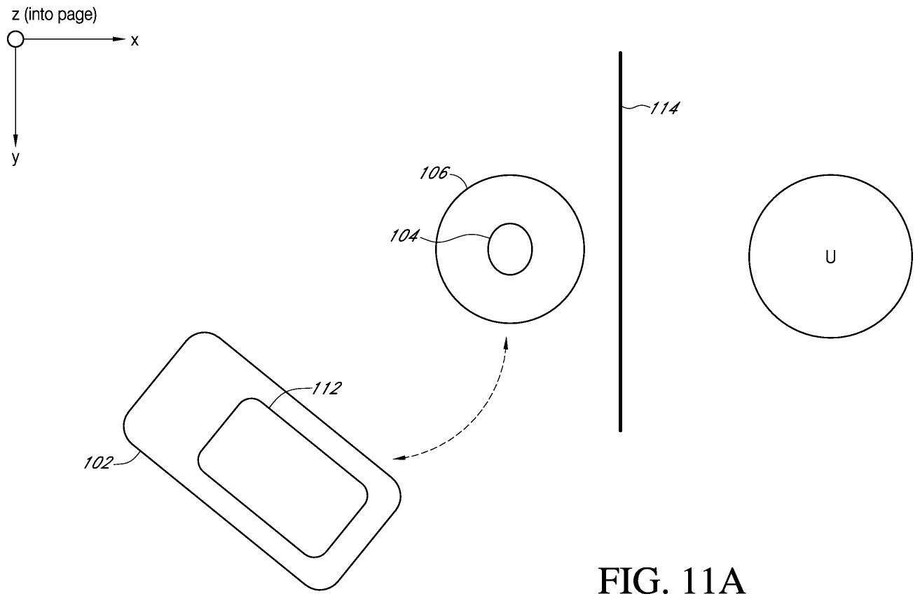

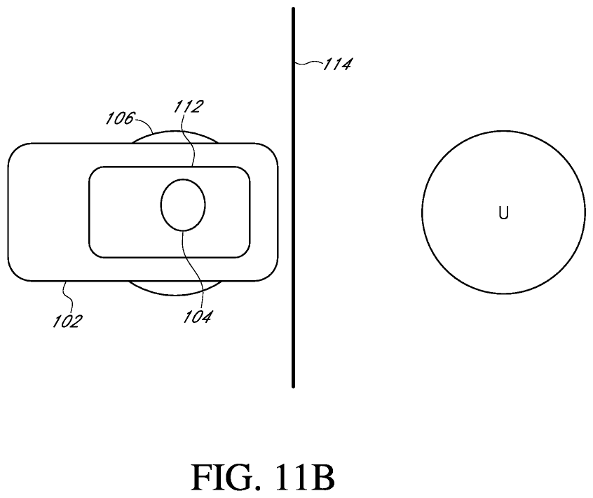

FIG. 11A provides a view looking down on a system according to the present disclosure before the wash manifold has been brought into engagement with the probe via linear movement in the x-direction. As shown, the user (located at location U) can be separated from one or more components of the system by housing 114. Probe 104 can be in register (in the x-y plane) with sample container 106 so as to allow for insertion of probe 104 into sample container 106.

After probe 104 has aspirated sample from sample container 106, relative motion between probe 104 and sample 106 can allow for wash manifold 102 (with receiving portion 112) to be moved (e.g., rotationally in the x-y plane) so as to place the receiving portion 112 into register with probe 104. This is shown in FIG. 11B, which provides a view looking down on a system according to the present disclosure after the wash manifold has been brought into engagement with the probe via linear movement in the x-direction. Rinse fluid (not shown) can be communicated through (and/or along the exterior of) probe 104 so as to remove undesired material (e.g., carryover from a previous sample run) from probe 104. It should also be understood that although rinse fluid can be communicated within the probe (i.e., along the inner surface of the probe), rinse fluid can also be communicated on the exterior of the probe as well. In this way, one can rinse the interior and exterior of the probe between sample runs.

The rinse fluid can then be collected by wash manifold 102 and transported to a waste collection location or transferred elsewhere for further processing.

The disclosed technology can also include additional features to catch, collect, and direct fluids. For example, a system according to the present technology can include one or more cups, gutters, or other fluid collectors or channels configured to collect fluid that exits the probe or that runs down the probe.

The disclosed technology can be configured such that the outer surface of the probe can be at least partially cleaned. In some embodiments, the outer surface of probe 104 is metal or other hydrophobic material such that liquid that may be present on the outer surface of the probe can accumulate, e.g., as a droplet at the end of the probe. Such liquid can then be removed from the outer surface of the probe when a vacuum is applied by the wash manifold, which vacuum can act to collect fluid that has passed through the interior of the probe (or that resides within the probe) as well as fluid that may be present on the exterior surface of the probe. Without being bound to any particular theory or embodiment, application of vacuum via the wash manifold acts to collect (e.g., via convective air movement) fluid on the interior and/or exterior of the probe, even if such fluid has not accumulated as a droplet on the probe.

Also without being bound to any particular theory or embodiment, communication of rinse fluid through the interior of the probe can also act to clean at least a portion of the exterior of the probe, in particular the end or tip of the probe. As an example, rinse fluid communicated through the interior of the probe that exits the end of the probe can splash or spray upwardly after exiting the end of the probe, e.g., via being deflected by a portion of the wash manifold, such as receiving portion 112 shown in FIG. 3. Such splashed/sprayed rinse fluid then contacts the exterior of the probe, thereby washing the probe exterior. This can be modulated in a variety of ways, including modulating the flowrate of the rinse fluid through the probe so as to achieve a flowrate sufficient to achieve the desired spray/splashing, and/or by providing a particular geometry in a portion of the wash manifold to encourage spraying and/or splashing of rinse fluid that is communicated through the probe.

A system according to the present disclosure can also include one or more additional modalities to wipe or otherwise clean the outer surface of probe 104. Such modalities can include, for example, air or gas streams, sprayers, wipers, and the like.

In addition to the foregoing, a system according to the present disclosure can also be configured to effect introduction of an air bubble into the probe, e.g., following the probe being rinsed with rinse fluid. In one such embodiment, the system can be configured to draw an amount of air (or other fluid) into the probe following the probe's rinsing with rinse fluid. Without being bound to any particular theory or embodiment, an air bubble into the probe can act as a buffer or spacer for the next sample that is drawn into the probe. As one non-limiting example, a system can be configured to rinse the probe with rinse fluid, and then, following the rinsing, draw an air bubble into the probe. When the probe is then used to collect the next sample, the air bubble in the probe can act as a buffer that “leads” the next sample such that the air bubble would enter the analysis portion of the system before the next sample. Although an air bubble can serve a number of purposes (e.g., to demarcate the beginning of a new sample or to otherwise act as a spacer), it should be understood that the presence of an air bubble is not a requirement.

It should also be understood that the disclosed systems and methods can include components (which components can be assembled into an apparatus or sub-system) configured to sense the motion and/or position of the probe. Exemplary such components and apparatuses are found in U.S. Pat. No. 10,890,596 (issued Jan. 12, 2021), the entirety of which patent is incorporated herein by reference for any and all purposes.

As one non-limiting example, a system according to the present disclosure can include a restorative spring, wherein the restorative spring is configured to stop the motion of the sampling probe toward an obstacle, and wherein the sampling probe is configured to sense the obstacle and to stop motion toward the obstacle.

The system can include an analog sensor configured to compensate for drift of the sampling probe by calibration along an axis of the sampling probe. The system can also include a sensor associated with the probe, the sensor being, e.g., one or more of a capacitive, an impedance, an optical, a displacement, and a pressure sensor. A system can also include an inductive force generator configured to impose a restoring force on the sampling probe.

The restorative spring can include a single magnet, three magnets, or a metal spring, for example. It should be recognized that the restorative spring according to various embodiments described herein can be any object or assembly that can provide sufficient restorative force to return the probe to a relaxed position. The restorative spring can be configured so as to provide sufficient restorative force to return the probe to a relaxed position, e.g., a position in which the probe is not inserted into the sample container, such as a washing position. In such an embodiment, a force can be exerted on the probe to move the probe from the relaxed position to an extended position (e.g., a sampling position) in which the probe is moved downward so as to be positioned to collect sample from a sample container.

A system according to the present disclosure can also include a sensor, such as a Hall effect sensor. The sensor can be configured to sense a field strength generated by the proximity of the restorative spring in the extended position.

Systems according to the present disclosure can include obstacle detection mechanisms. Such mechanisms can reduce costs and increase time savings by reducing both instrument downtime and increasing probe position accuracy and durability. A system according to the present disclosure can be configured to provide position feedback that reduces or eliminates damage to the probe in cases of collisions and calibrates the location of the probe in three-dimensional space.

In one embodiment, a system according to the present disclosure can include a magnet-based probe with opposing magnets that provide force to push the probe back to a normal state after it has been depressed in contact with another object. The system can also include a Hall effect sensor that detects a change in magnetic field when the magnets are pushed closer to each other as the probe is depressed from its relaxed position. A probe can include a fitting, which fitting can include an elongated portion extending from the fitting. Such a system can also include a restorative spring including a plurality of magnets inserted onto the elongated portion.

The magnet or magnets of the restorative spring can be of any magnet type. For example, the magnets can be rare earth magnets to provide for denser field strength and longer magnetic life. As described elsewhere herein, the probe or system can also include a Hall effect sensor to detect magnetic field changes as magnets are pushed together or allowed to move apart. The probe can be used for drawing samples from a sample plate. The probe can be moved by interference with an obstructing object upon detection of changes in Hall effect sensor readings by the Hall effect sensor so as to retract the probe from the obstructing object and avoid damage to the probe.

In some embodiment, the probe can normally be in an extended position with opposing magnets forcing themselves apart and thereby driving the probe to the extended position. The Hall effect sensor can transmit a signal relative to the field strength generated by the restorative spring in the extended position. As the probe is moved toward the sample container (which can also be a sample plate) and comes in contact with a surface, the opposing magnets of the restorative spring are forced together, thereby increasing the field strength sensed by the Hall effect sensor and changing the signal from the Hall effect sensor.

This change in signal can be interpreted by the software as motion of the probe relative to the rest of the system. The software can then stop the motion of the probe so that the probe is not damaged by being forced against the interfering object.

In some embodiments, the probe can be magnet-based and can use a Hall effect sensor, which can improve reliability and sealing. Although the sensor can be a Hall effect sensor that uses a magnetic field for detection, to sense, react, and stop in the event of unexpected contact, any sensor that can sense the displacement of the probe once in contact with a surface could also be used. For example, capacitive, impedance, optical, displacement, pressure, and other sensors can be used. Further, although the restoring force for the probe can be magnet-based, other restoring forces can also be used, including a restorative spring, an inductive force generator, or other mechanisms to impose a restoring force on the probe. Magnetic repulsion is considered especially suitable, as it provides a soft restorative force and increases sensor sensitivity by compacting field lines. When an obstacle is detected, the user may be notified that there was an obstacle and that sampling should not proceed. An error may also be generated and indicated to the user.

It should be understood that the displacement of the probe can be sensed by monitoring the location of one or more markers associated with the probe's position. As one example, a probe (and/or a fitting associated with the probe) can comprise optically-detectable markers (which markers can be visible to the eye and/or visible under specific illumination conditions, such as ultraviolet illumination). Such markers can be sensed by optical sensors, which optical sensors in turn provide a signal indicative of the probe's position. Should the signal indicate that the probe's position lies within a certain range of positions (or, depending on the circumstance, lie outside a certain range of positions), the system can be configured to move the probe, e.g., to retract the probe so as to avoid exerting the probe against an object known to be present at a certain location.

In some embodiments, when the probe is retracted from the interfering object, software can sense the Hall effect signal returning to the steady state value. When the system is in a resting position, the software can calibrate the steady state to the Hall effect signal value, and any changes in magnetic field, position of the probe, or Hall effect sensor can be calibrated out every time the system returns to a rest position. This also allows the probe to track and discard any drift in the electronic signal that can occur over longer time periods. Further, knowledge that the probe can have touched an object can be used to calibrate all three dimensions of the system. This can be done by moving the probe to a series of known locations with unique three-dimensional coordinates. As the probe touches each known location, the system can calibrate the current position to the known coordinates of that position. Then, by touching several locations, the system can calibrate location in all three operational axes.

The disclosed systems can thus be configured to prevent (or at least reduce) probe interference with a sample container and/or a wash manifold. As but one example, one or more magnets can be located on the sample probe and/or on a fitting or other extension engaged with the probe. One or more magnets can be located elsewhere within the system, e.g., on a flange or other fitting located adjacent to the probe.

Aspects

The following Aspects are illustrative only and do not serve to limit the scope of the present disclosure or the appended claims.

Aspect 1. A fluid sample handling system, comprising:
a sample container holder configured to receive a sample container, the sample container holder optionally being moveable between at least (1) a first sample holder position and (2) a second sample holder position;
a sample probe, the sample probe defining a proximal end configured for fluid communication with the sample container, the sample probe configured to communicate therethrough, in a first direction, fluid aspirated from the sample container, the sample probe defining a sample probe axis along which the sample probe is optionally moveable between at least (1) a first sample probe position for aspirating fluid from the sample container when the sample holder is located at the first sample holder position and (2) a second sample probe position for washing;
a wash manifold, the wash manifold being moveable along a wash manifold path between at least a first wash manifold position and a second wash manifold position, the second wash manifold position being such that when the wash manifold is located at the second position, the wash manifold receives fluid communicated from the proximal end of the sample probe when the sample probe is located at the second probe position and the wash manifold interrupts fluid communication between the proximal end of the sample probe and a sample container received by the sample holder, and the wash manifold path optionally being perpendicular to the sample probe axis.

A system according to the present disclosure can also include a housing, which housing can at least partially enclose one or more of the sample container holder, the sample probe, and the wash manifold. The housing can be opaque, but this is not a requirement, as the housing can also be translucent or even transparent. The housing can have mounted thereon one or more magnets (which one or more magnets can also be mounted on one or more fittings associated with the housing); as described elsewhere herein, said magnets can be part of an apparatus or arrangement configured to sense the motion and/or position of the probe. Exemplary such components and apparatuses are found in U.S. Pat. No. 10,890,596 (issued Jan. 12, 2021), the entirety of which patent is incorporated herein by reference for any and all purposes.

A sample container holder can include a clip, a clamp, or other gripping modality configured to secure a sample container to the sample container holder. Spring-loaded modalities are considered especially suitable, but are not required. The sample container holder can be moveable upwards and downwards (e.g., in the z-direction in an x-y-z coordinate system). The movement of the sample container holder can be effected manually by a user and/or in an automated fashion by which the movement of the sample container holder is at least partially modulated in an automated fashion. The movement of the sample container holder can be modulated by one or more stops, detents, or other features that retard or even stop movement of the sample holder at one or more locations along a path of travel. For example, a sample container holder can be held in a loading position from which it can be released only by the user pressing a button or actuates some other element so as to free or release the sample container holder. Similarly, a system can be configured such that the sample container holder cannot be moved into a sampling position (e.g., a position where the probe aspirates sample from the sample container held by the sample container holder) until the user presses a button or actuates some other element to allow the sample container holder to move into the sampling position.

A sample probe (also termed “probe” in some locations) can be, e.g., a tube or capillary. The sample probe can itself be moveable along an axis (e.g., upwards and downwards along a z-axis in an x-y-z coordinate system) so as to place the sample probe into engagement with a sample container engaged with the sample container holder. It should be understood, however, that a system can operate via relative motion between the sample probe and the sample probe holder, i.e., that one or both of the sample probe and the sample probe holder can be moveable or actually move. As one example, the probe can remain stationary while the sample container holder moves toward the probe and away from the probe. As another example, the probe can move or be moved toward or away from the sample container holder.

The wash manifold can (as shown in the attached figures) be moved in along one or more linear pathways, but can also be moved in a rotational fashion. In a first position, the wash manifold can be free of fluid communication with the probe; in a second position, the wash manifold can be positioned so as to receive rinse fluid (or any other material) that is communicated within the probe or along the exterior of the probe. A wash manifold can include one or more catch portions (e.g., a tank) configured to catch or retain rinse fluid. A wash manifold can include one or more channels or other conduits that are in fluid communication with a source of vacuum, a waste location, or other element exterior to the wash manifold.

Aspect 2. The fluid sample handling system of Aspect 1, further comprising a source of rinse fluid, the source of rinse fluid configured for communication of rinse fluid through the sample probe. The communication of rinse fluid can be effected when the probe is in any position that places the probe into fluid communication with the source of rinse fluid. For example, the source of rinse fluid can be configured such that rinse fluid is delivered to the sample probe only when the sample is in a certain position.

Aspect 3. The fluid sample handling system of any one of Aspects 1-2, further comprising a vacuum source configured to effect motion of fluid received by the wash manifold.

Aspect 4. The fluid sample handling system of any one of Aspects 1-3, further comprising a linear motion stage configured to effect motion of the sample probe between a first sample holder position and a second sample holder position.

Aspect 5. The fluid sample handling system of any one of Aspects 1-4, further comprising a motion stage configured to effect motion of the wash manifold between the first wash manifold position and the second wash manifold position. The motion stage can be a linear motion stage, but can also be a rotational motion stage.

Aspect 6. The fluid sample handling system of any one of Aspects 1-5, wherein the sample container holder is manually moveable between the first sample holder position and the second sample holder position. As described elsewhere herein, the sample container holder can be moved in an automated fashion between positions. Also as described herein, a system can include one or more latches, detents, or other features configured to retard or even stop motion of the sample container holder. As an example, a system can include a latch configured to prevent the sample container holder being moved from a first position to a second position without user approval, e.g., pressing a button or otherwise releasing the sample container holder from the first position.

Aspect 7. The fluid sample handling system of any one of Aspects 1-6, further comprising a housing, the housing being configured such that the sample container holder is visible to a user and the wash manifold is separated from the user.

Aspect 8. The fluid sample handling system of Aspect 7, wherein the housing is configured so as to separate the probe from the user when the probe is in the second sample probe position.

Aspect 9. The fluid sample handling system of any one of Aspects 1-8, further comprising a restorative spring, the restorative spring being configured to oppose the motion of the sample probe toward an obstacle.

Aspect 10. The fluid sample handling system of Aspect 9, wherein the restorative spring comprises a metal spring, a magnet, or any combination thereof.

Aspect 11. The fluid sample handling system of Aspect 10, wherein the restorative spring comprises a metal spring.

Aspect 12. The fluid sample handling system of any one of Aspects 1-11, further comprising a sensor configured to detect a location of the sample probe.

Aspect 13. The fluid sample handling system of any one of Aspects 9-12, wherein the fluid sample handling system is configured to stop a motion of the probe in response to a signal associated with a location of the probe.

Aspect 14. A method, comprising operating a fluid sample system of any one of Aspects 1-13 so as to aspirate a fluid from a sample container into the sample probe.

Aspect 15. The method of Aspect 9, further comprising operating the fluid sample system so as to effect communication of rinse fluid through the sample probe following aspiration of fluid from the sample container into the sample probe. One can also operate the system so as to communicate rinse fluid onto an exterior surface of the sample probe.

Aspect 16. A fluid sample handling system, comprising:

a sample container region;

a probe configured for aspiration of a fluid sample from a sample container located at the sample container region; and

a wash manifold,

the fluid sample handling system being convertible between:

a sampling state in which the probe is in a sampling position and the sample container region is in a sampling position such that the probe is in fluid communication with a container located at the sample container region,

a washing state in which the probe is in a washing position and the wash manifold is in a washing position such that the probe is in fluid communication with the wash manifold and the probe is free of fluid communication with a container located at the sample container region, and

a loading state in which the sample container region is in a loading position such that a user can locate a container at the sample container region without placing the container into fluid communication with the probe.

A sample container region can be a sample container holder or other element that is occupied by a sample container or that otherwise engages with a sample container.

The sampling state can be achieved by relative motion between the probe and the container that contains the sample. As an example, the probe can be moved so as to insert the probe into the container, the container can be moved such that the probe becomes inserted into the container, or any combination thereof.

The loading state can similarly be achieved by relative motion between the probe and the container that contains the sample. Such relative motion can result in the probe and sample container being located at a distance from one another, which distance is sufficient to allow a user to introduce sample into the sample container without interference by (or with) the probe.

Aspect 17. The fluid sample handling system of Aspect 16, wherein in the loading state, the probe is in a loading position such that the probe is free of fluid communication with a container located at the sample container region when the sample container region is in its loading position. The loading state can be achieved by, e.g., effecting relative motion between the probe and the sample container region.

Aspect 18. The fluid sample handling system of any one of Aspects 16-17, further comprising a housing, the housing being configured such that the sample container holder is visible to a user and the wash manifold is separated from the user. (A housing can be opaque, but can also be translucent or even transparent.)

Aspect 19. A method, comprising:

with a probe in a sampling position, collecting a sample from a sample container in a sampling position;

translating the probe in a direction of probe translation to a washing position;

washing the probe with a rinse fluid while the probe is in the washing position; and

collecting the rinse fluid from the probe.

Sample collected from the sample container can be communicated by the probe to another section of a system (e.g., a particle concentration train, such as a concentration train that operates by acoustic radiation pressure, a concentration train that operates by hydrodynamic focusing).

Aspect 20. The method of Aspect 19, wherein the probe is visible to a user when the probe is in the sampling position and wherein the probe is separated from the user when the probe is in the washing position. The separation can be such that the user cannot physically access the probe.

In some embodiments, the probe can be separated from the user when the probe is in the sampling position and also separated from the user when the probe is in the washing position.

Aspect 21. The method of any one of Aspects 19-20, further comprising translating the sampling container from a sampling position to a loading position.

Aspect 22. The method of Aspect 19 wherein the sample container is engaged with a sample container holder moveable so as to place the sample container in the sampling position and in the loading position.

Aspect 23. The method of any one of Aspects 19-22, wherein the rinse fluid is collected by a wash manifold located at a collection position.

Aspect 24. The method of Aspect 23, further comprising translating the wash manifold in a direction of wash manifold translation from the collection position to a standby position.

Aspect 25. The method of Aspect 24, wherein the translating the wash manifold is in a direction essentially perpendicular to the direction of probe translation.

Aspect 26. A method, comprising

effecting movement of a probe toward a sample container,

in response to the sample probe being located at a first sample probe position, with a first restorative spring effecting resistance against the movement of the probe toward the sample container;

collecting a sample with the probe from a sample container;

effecting movement of the sample probe toward a wash manifold;

in response to the sample probe being located at a second sample probe position, with a second restorative spring effecting resistance against the movement of the probe toward the wash manifold;

washing the probe with a rinse fluid while the probe is in the washing position; and

collecting the rinse fluid from the probe.

Aspect 27. The method of Aspect 26, further comprising communicating the sample from the probe.

Aspect 28. The method of any one of Aspects 26-27, wherein at least one of the first restorative spring and the second restorative spring comprises a metal spring, a magnet, or any combination thereof.

Aspect 29. The method of any one of Aspects 26-28, wherein at least one of the first position of the sample probe and the second position of the sample probe is detected by a Hall effect sensor, a capacitive sensor, an impedance sensor, an optical sensor, a displacement sensor, a pressure sensor, or any combination thereof.

Aspect 30. The method of any one of Aspects 26-29, further comprising (a) effecting stoppage of the movement of the probe toward the sample container in response to a signal indicative of a position of the probe, (b) effecting stoppage of the movement of the probe toward the wash manifold in response to a signal indicative of a position of the probe, or both (a) and (b).

1. A fluid sample handling system, comprising:
a sample container holder configured to receive a sample container,
the sample container holder being moveable between at least (1) a first sample holder position and (2) a second sample holder position;
a sample probe,
the sample probe defining a proximal end configured for fluid communication with the sample container,
the sample probe configured to communicate therethrough, in a first direction, fluid aspirated from the sample container,
the sample probe defining a sample probe axis along which the sample probe is optionally moveable between at least (1) a first sample probe position for aspirating fluid from the sample container when the sample holder is located at the first sample holder position and (2) a second sample probe position for washing;
a wash manifold,
the wash manifold being moveable along a wash manifold path between at least a first wash manifold position and a second wash manifold position,
the second wash manifold position being such that when the wash manifold is located at the second position, the wash manifold receives fluid communicated from the proximal end of the sample probe when the sample probe is located at the second probe position and the wash manifold interrupts fluid communication between the proximal end of the sample probe and a sample container received by the sample holder, and
the wash manifold path optionally being perpendicular to the sample probe axis.

2. The fluid sample handling system of claim 1, further comprising a source of rinse fluid, the source of rinse fluid configured for communication of rinse fluid through the sample probe.

3. The fluid sample handling system of claim 1, further comprising a vacuum source configured to effect motion of fluid received by the wash manifold.

4. The fluid sample handling system of claim 1, further comprising a linear motion stage configured to effect motion of the sample probe between the first sample holder position and the second sample holder position.

5. The fluid sample handling system of claim 1, further comprising a motion stage configured to effect motion of the wash manifold between the first wash manifold position and the second wash manifold position.

6. The fluid sample handling system of claim 1, wherein the sample container holder is manually moveable between the first sample holder position and the second sample holder position.

7. The fluid sample handling system of claim 1, further comprising a housing, the housing being configured such that the sample container holder is visible to a user and the wash manifold is separated from the user, wherein the housing is optionally configured so as to separate the probe from the user when the probe is in the second sample probe position.

8. (canceled)

9. The fluid sample handling system of claim 1, further comprising a restorative spring, the restorative spring being configured to oppose the motion of the sample probe toward an obstacle.

10. The fluid sample handling system of claim 9, wherein the restorative spring comprises a metal spring, a magnet, or any combination thereof.

11. (canceled)

12. The fluid sample handling system of claim 1, further comprising a sensor configured to detect a location of the sample probe, and wherein the fluid sample handling system is configured to stop a motion of the probe in response to a signal associated with a location of the probe.

13. (canceled)

14. A method, comprising operating a fluid sample system of claim 1 so as to aspirate a fluid from a sample container into the sample probe.

15. (canceled)

16. A fluid sample handling system, comprising:
a sample container region;
a probe configured for aspiration of a fluid sample from a sample container located at the sample container region; and
a wash manifold,
the fluid sample handling system being convertible between:
(a) a sampling state in which the probe is in a sampling position and the sample container region is in a sampling position such that the probe is in fluid communication with a container located at the sample container region,
(b) a washing state in which the probe is in a washing position and the wash manifold is in a washing position such that the probe is in fluid communication with the wash manifold and the probe is free of fluid communication with a container located at the sample container region, and
(c) a loading state in which the sample container region is in a loading position such that a user can locate a container at the sample container region without placing the container into fluid communication with the probe.

17. The fluid sample handling system of claim 16, wherein in the loading state, the probe is in a loading position such that the probe is free of fluid communication with a container located at the sample container region when the sample container region is in its loading position.

18. The fluid sample handling system of claim 16, further comprising a housing, the housing being configured such that the sample container holder is visible to a user and the wash manifold is separated from the user.

19. A method, comprising:
with a probe in a sampling position, collecting a sample from a sample container in a sampling position;
translating the probe in a direction of probe translation to a washing position;
washing the probe with a rinse fluid while the probe is in the washing position; and
collecting the rinse fluid from the probe.

20. (canceled)

21. The method of claim 19, further comprising translating the sampling container from a sampling position to a loading position.

22. The method of claim 19, wherein the sample container is engaged with a sample container holder moveable so as to place the sample container in the sampling position and in the loading position.

23. The method of claim 19, wherein the rinse fluid is collected by a wash manifold located at a collection position.

24. The method of claim 23, further comprising translating the wash manifold in a direction of wash manifold translation from the collection position to a standby position.

25. The method of claim 24, wherein the translating the wash manifold is in a direction essentially perpendicular to the direction of probe translation.

26. (canceled)

27. (canceled)

28. (canceled)

29. (canceled)

30. (canceled)
